(19) United States
(12) Patent Application Publication
(10) Pub. No.: US 2018/0185850 A1
(43) Pub. Date: Jul. 5, 2018

(54) DISTRIBUTION MEMBER AND VERTICAL SHAFT IMPACT CRUSHER INCLUDING THE SAME

(71) Applicants: Hong-Soon Hur, Gyeongsan-si (KR); Jin-Hee Hur, Bundang-gu, Seongnam-si (KR)

(72) Inventors: Hong-Soon Hur, Gyeongsan-si (KR); Jin-Hee Hur, Bundang-gu, Seongnam-si (KR)

(21) Appl. No.: 15/739,362

(22) PCT Filed: Jun. 20, 2016
(86) PCT No.: PCT/KR2016/006505

§ 371 Date: Dec. 22, 2017

(30) Foreign Application Priority Data
Jul. 2, 2015 (KR) 10-2015-0094557

(51) Int. Cl. B02C 13/18; B02C 13/28; B02C 13/286; B02C 2/00

(52) U.S. Cl. CPC B02C 13/185; B02C 13/2804; B02C 13/30; B02C 2/007; B02C 13/286

(57) ABSTRACT

A distribution member may include a distributing plate, a plurality of protecting plates and a second protecting plate. The distributing plate may be connected with a vertical shaft of the vertical shaft impact crusher. The distributing plate may have a first distributing surface having a conical shape, and a second distributing surface. The first protecting plates may be attached to the first distributing surface of the distributing plate. The second protecting plate may be attached to the second distributing surface of the distributing plate. Thus, the distribution member may be semi-permanently used by properly exchanging any one of the first protecting plates and/or the second protecting plate.

### CROSS-RELATED APPLICATION

This application claims priority under 35 USC § 119 to Korean Patent Application No. 10-2015-0094557, filed on Jul. 2, 2015 in the Korean Intellectual Property Office (KIPO), the contents of which are herein incorporated by reference in their entirety.

### BACKGROUND

### 1. Field

Example embodiments relate to a distribution member and a vertical shaft impact crusher including the same. More particularly, example embodiments relate to a distribution member configured to horizontally distribute natural aggregates vertically loaded into a vertical shaft impact crusher for pulverizing the natural aggregates to form gravels and sands, and a vertical shaft impact crusher including the distribution member.

### 2. Description of the Related Art

Natural aggregates may be pulverized using a crusher in accordance with various applications. The crusher may include a vertical shaft impact crusher. The vertical shaft impact crusher may pulverize the natural aggregates by crushing the highly accelerated aggregates against a crushing surface. The vertical shaft impact crusher may be classified into an anvil type crusher and a rock-on-rock type crusher.

According to related arts, the anvil type impact crusher may include a crushing chamber and a feeding hopper arranged over the crushing chamber. A rotor configured to provide the natural aggregates with a centrifugal force may be arranged in the crushing chamber. The natural aggregates may be loaded into the rotor through the feeding hopper. A conical distribution member may be arranged on a central portion of a bottom surface of the rotor. The distribution member may be configured to distribute the natural aggregates vertically loaded into the rotor in a horizontal direction. The distribution member may be connected with a vertical shaft configured to rotate the rotor. Thus, the distribution member may be rotated together with the rotor. An anvil may be installed at an inner surface of the crushing chamber. The natural aggregates horizontally distributed by the distribution member may be crushed against the anvil.

The natural aggregates loaded into the rotor may be crushed against the distribution member. The crushed natural aggregates may then be distributed in the horizontal direction by the distribution member. Therefore, the distribution member rapidly rotated with the rotor may greatly make friction with the natural aggregates. As a result, because the distribution member may be easily worn, it may be required to periodically exchange the worn distribution member with a new distribution member.

### SUMMARY

Example embodiments provide a member of a vertical shaft impact crusher having an extended exchange period.

Example embodiments also provide a vertical shaft impact crusher including the above-mentioned distribution member.

According to example embodiments, there may be provided a distribution member of a vertical shaft impact crusher. The distribution member may include a distributing plate, a plurality of protecting plates and a second protecting plate. The distributing plate may be connected with a vertical shaft of the vertical shaft impact crusher. The distributing plate may have a first distributing surface having a conical shape, and a second distributing surface. The first protecting plates may be attached to the first distributing surface of the distributing plate. The second protecting plate may be attached to the second distributing surface of the distributing plate.

In example embodiments, the second distributing surface may be substantially perpendicular to an axial direction of the vertical shaft. The first distributing surface may be slantly extended from an outer end of the second distributing surface in a radius direction of the distributing plate.

In example embodiments, the distributing plate may have a receiving groove configured to receive bolts for fixing the first protecting plates and the second protecting plate to the first distributing surface and the second distributing surface, respectively.

In example embodiments, a protecting tip may be attached to an end of each of the bolts oriented toward the first protecting plates and the second protecting plate.

In example embodiments, the protecting tip may include a hard metal.

In example embodiments, the first protecting plates may include a plurality of inner protecting plates and a plurality of outer protecting plates. The inner protecting plates may be arranged in a circumferential direction of the distributing plate. Each of the inner protecting plates may have an inner surface configured to make contact with an outer surface of the second protecting plate. The outer protecting plates may be arranged in the circumferential direction of the distributing plate. The outer protecting plates may be configured to make contact with outer surface of the inner protecting plates.

In example embodiments, each of the inner and outer protecting plates may have a rounded upper surface and a rounded lower surface.

In example embodiments, the second protecting plate may include a plurality of plates arranged in a circumferential direction of the second distributing surface in the distributing plate.

In example embodiments, the distribution member may further include a third protecting plate attached to an outer surface of the distributing plate.

In example embodiments, the outer surface of the distributing plate may have a tapered shape. The third protecting plate may have an inner surface configured to make contact with the tapered outer surface of the distributing plate.

In example embodiments, the distributing plate may have a locking portion formed on the outer surface of the distributing plate. A locking groove into which the locking portion may be inserted may be formed at an inner surface of the third protecting plate.

In example embodiments, the third protecting plate may include a hard metal.

In example embodiments, the distribution member may further include a fourth protecting plate attached to an inner surface of the distributing plate.

In example embodiments, the fourth protecting plate may have an upper end protruded from the second distributing surface. The second protecting plate may have a receiving groove configured to receive the upper end of the fourth protecting plate.

In example embodiments, the fourth protecting plate may include a hard metal.

In example embodiments, the first protecting plates and the second protecting plate may include a hard metal.

In example embodiments, the distribution member may further include a bolt configured to connect the distributing plate with the vertical shaft.

In example embodiments, a protecting cover may be attached to a head of the bolt.

In example embodiments, the protecting cover may include a hard metal.

According to example embodiments, there may be provided a vertical shaft impact crusher. The vertical shaft impact crusher may include a crushing housing, a feeding hopper, a rotor, a vertical shaft, a distribution member and an anvil. The feeding hopper may be arranged over the crushing housing to provide the crushing housing with natural aggregates. The rotor may be arranged in the crushing housing to provide the natural aggregates with a centrifugal force. The vertical shaft may provide the rotor with the centrifugal force. The distribution member may include a distributing plate, a plurality of protecting plates and a second protecting plate. The distributing plate may be arranged on a bottom surface of the rotor. The distributing plate may be connected with a vertical shaft of the vertical shaft impact crusher. The distributing plate may have a first distributing surface having a conical shape, and a second distributing surface. The first protecting plates may be attached to the first distributing surface of the distributing plate. The second protecting plate may be attached to the second distributing surface of the distributing plate. The anvil may be crushed to the natural aggregates distributed by the distribution member.

According to example embodiments, the first protecting plates and the second protecting plate including the hard metal may prevent the first protecting surface and the second protecting surface of the distributing plate from being worn. Particularly, any one among the first protecting plates, which may be relatively more worn, may be exchanged with a new one. Thus, the distribution member may be semipermanently used by properly exchanging any one of the first protecting plates and/or the second protecting plate.

### BRIEF DESCRIPTION OF THE DRAWINGS

Example embodiments will be more clearly understood from the following detailed description taken in conjunction with the accompanying drawings. FIGS. 1 to 9 represent non-limiting, example embodiments as described herein.

FIG. 1 is an exploded perspective view illustrating a distribution member of a vertical shaft impact crusher in accordance with example embodiments;

FIG. 2 is a perspective view illustrating the distribution member in FIG. 1;

FIG. 3 is a cross-sectional view illustrating the distribution member in FIG. 2;

FIG. 4 is a plan view illustrating the distribution member in FIG. 2;

FIG. 5 is a cross-sectional view taken along a line V-V′ in FIG. 4;

FIG. 6 is a cross-sectional view taken along a line VI-VI′ in FIG. 4;

FIG. 7 is a cross-sectional view illustrating a distribution member of a vertical shaft impact crusher in accordance with example embodiments;

FIG. 8 is a cross-sectional view illustrating a distribution member of a vertical shaft impact crusher in accordance with example embodiments; and

FIG. 9 is a cross-sectional view illustrating a vertical shaft impact crusher including the distribution member in FIG. 1.

### DETAILED DESCRIPTION OF THE EMBODIMENTS

Various example embodiments will be described more fully hereinafter with reference to the accompanying drawings, in which some example embodiments are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

Distribution Member

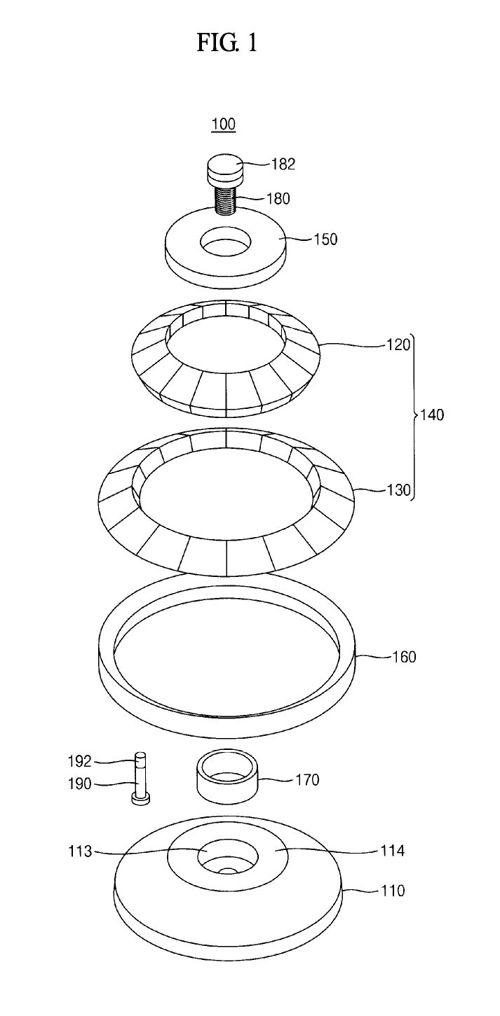

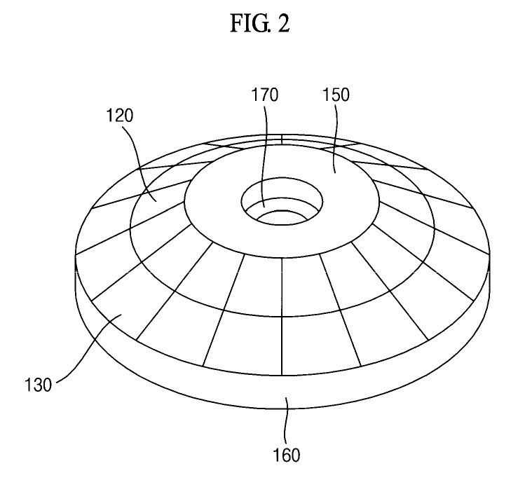

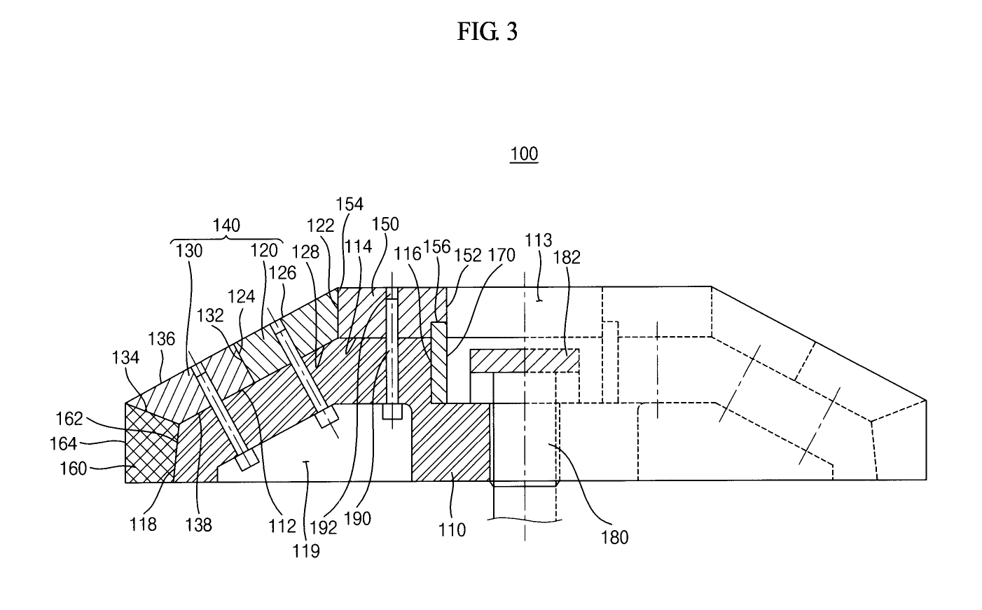

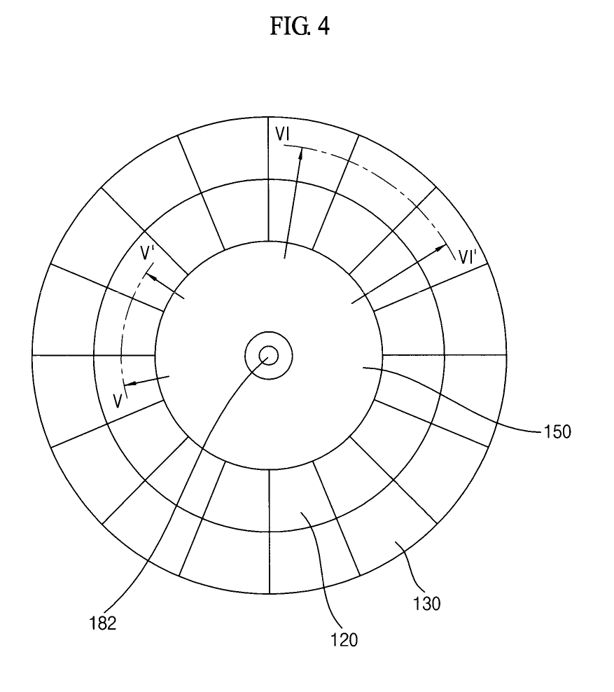

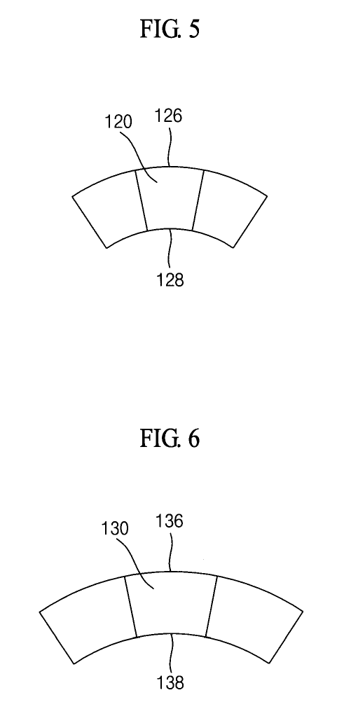

FIG. 1 is an exploded perspective view illustrating a distribution member of a vertical shaft impact crusher in accordance with example embodiments, FIG. 2 is a perspective view illustrating the distribution member in FIG. 1, FIG. 3 is a cross-sectional view illustrating the distribution member in FIG. 2, FIG. 4 is a plan view illustrating the distribution member in FIG. 2, FIG. 5 is a cross-sectional view taken along a line V-V′ in FIG. 4, and FIG. 6 is a cross-sectional view taken along a line VI-VI′ in FIG. 4.

Referring to FIGS. 1 to 6, a distribution member 100 of a vertical shaft impact crusher in accordance with example embodiments may include a distributing plate 110, a plurality of first protecting plates 140, a second protecting plate 150, a third protecting plate 160 and a fourth protecting plate 170.

The distributing plate 110 may have a conical shape. The distributing plate 110 may have an axial hole 113 into which a vertical shaft of the vertical shaft impact crusher may be inserted. The conical distributing plate 110 may have an inner surface 116, an outer surface 118, an upper surface and a lower surface. Natural aggregates may be crushed against the upper surface of the distributing plate 110. The crushed natural aggregates may then be distributed in a horizontal direction. Thus, the upper surface of the distributing plate 110 may correspond to a distributing surface configured to horizontally distribute the natural aggregates.

In example embodiments, the upper surface of the distributing plate 110 may be divided into a first distributing surface 112 and a second distributing surface 114. The first distributing surface 112 may have a conical shape. The second distributing surface 114 may have a flat shape substantially parallel to the horizontal direction. The second distributing surface 114 may be positioned adjacent to the axial hole 114 of the distributing plate 110. The first distributing surface 112 may be slantly extended from an outer end of the second distributing surface 114 in a radius direction of the distributing plate 110. Thus, as mentioned above, the first distributing surface 112 may have the conical shape.

The outer surface 118 of the distributing plate 110 may have a tapered shape with respect to an axial direction of the axial hole 113. Particularly, the tapered outer surface 118 of the distributing plate 110 may have a gradually increased width from the upper surface to the lower surface of the distributing plate 110. Thus, a radius from a center point of the distributing plate 110 to an upper end of the tapered outer surface 118 may be shorter than a radius from the center point of the distributing plate 110 to a lower end of the tapered outer surface 118.

The first protecting plates 140 may be configured to protect the first distributing surface 112 of the distributing plate 110. The first protecting plates 140 may make contact with the first distributing surface 112 of the distributing plate 110. In example embodiments, the first protecting plates 140 may include a plurality of inner protecting plates 120 and a plurality of outer protecting plates 130. Numbers of the inner and outer protecting plates 120 and 140 may not be restricted within a specific number.

The inner protecting plates 120 may be arranged along an inner circumferential line of the distributing plate 110. The inner circumferential line may correspond to a line connecting an upper portion of the first distributing surface 112 with each other. Thus, the inner protecting plates 120 may make contact with the upper portion of the first distributing surface 112 in the distributing plate.

The inner protecting plates 120 may have substantially the same size and shape. Each of the inner protecting plates 120 may have an isosceles trapezoidal shape. Thus, each of the inner protecting plates 120 may have an inner surface 122, an outer surface 124, an upper surface 126 and a lower surface 128. The inner surface 122 of the inner protecting plate 120 may make contact with the second protecting plate 150. The outer surface 124 of the inner protecting plate 120 may make contact with the outer protecting plate 130. The lower surface 128 of the inner protecting plate 120 may make contact with the upper portion of the first distributing surface 112 in the distributing plate 110. Because the first distributing surface 112 of the distributing plate 110 may have the conical shape, the first distributing surface 112 may have a rounded shape having a constant curvature. Therefore, the lower surface 128 of the inner protecting plate 120 may have a rounded shape having a curvature substantially the same as the curvature of the first distributing surface 112. The upper surface 126 of the inner protecting plate 120 may also have a rounded shape likewise the lower surface 126 of the inner protecting plate 120.

The outer protecting plates 130 may be arranged along an outer circumferential line of the distributing plate 110. The outer circumferential line may correspond to a line connecting a lower portion of the first distributing surface 112 with each other. A radius from the center point of the distributing plate 110 to the outer circumferential line may be longer than a radius from the center point of the distributing plate to the inner circumferential line. Thus, the outer protecting plates 130 may make contact with the lower portion of the first distributing surface 112 in the distributing plate.

The outer protecting plates 130 may have substantially the same size and shape. Each of the outer protecting plates 130 may have an isosceles trapezoidal shape. Thus, each of the outer protecting plates 130 may have an inner surface 132, an outer surface 134, an upper surface 136 and a lower surface 138. The inner surface 132 of the outer protecting plate 130 may make contact with the inner surface 124 of the inner protecting plate 120. The outer surface 134 of the outer protecting plate 130 may make contact with the third protecting plate 160. The lower surface 138 of the outer protecting plate 130 may make contact with the lower portion of the first distributing surface 112 in the distributing plate 110. Because the first distributing surface 112 of the distributing plate 110 may have the rounded shape having the constant curvature, the lower surface 138 of the outer protecting plate 130 may have a rounded shape having a curvature substantially the same as the curvature of the first distributing surface 112. The upper surface 136 of the outer protecting plate 130 may also have a rounded shape likewise the lower surface 136 of the outer protecting plate 130.

The first protecting plate 140 may include a hard metal such as tunsten carbide. The first protecting plate 140 may function as to protect the first distributing surface 112 of the distributing plate 110 from the crushing of the natural aggregates. Because the first protecting plate 140 including the hard metal may include the inner protecting plates 120 and the outer protecting plates 130, relatively more worn one among the inner and outer protecting plates 120 and 130 may be exchanged with a new protecting plate.

Alternatively, the first protecting plate 140 may include only one of the inner protecting plates 120 and the outer protecting plates 130. Further, the first protecting plate 140 may further include at least one row of middle protecting plates between the inner protecting plates 120 and the outer protecting plates 130.

The first protecting plate 140 may be fixed to the first distributing surface 112 of the distributing plate 110 using a bolt 190. The bolt 190 may be threaded from the lower surface of the distributing plate 110 to the first protecting plate 140. The distributing plate 110 may have a receiving groove 119 configured to receive the bolt 190. The receiving groove 119 may be formed at the lower surface of the distributing plate 110. Thus, the bolt 190 may have a head exposed through the receiving groove 119. In contrast, the bolt 190 may have an end exposed through the upper surface of the first protecting plate 140. In order to prevent the end of the bolt 190 from being crushed and worn with the natural aggregates, a protecting tip 192 may be attached to the end of the bolt 190. The protecting tip 192 may be attached to the end of the bolt 190 by a brazing process.

The second protecting plate 150 may protect the second distributing surface 114 of the distributing plate 110. The second protecting plate 150 may be configured to make contact with the second distributing surface 114 of the distributing plate 110. In example embodiments, the second protecting plate 150 may have an annular shape. Thus, the second protecting plate 150 may have an upper surface, a lower surface, an inner surface 152 and an outer surface 154. The lower surface of the second protecting plate 150 may make contact with the second distributing surface 114 of the distributing plate 110. A receiving groove 156 may be formed at the inner surface 152 of the second protecting plate 150. The second protecting plate 150 may include a hard metal such as tungsten carbide. The second protecting plate 150 may function as to protect the second distributing surface 114 of the distributing plate 110 from the crushing of the natural aggregates.

The second protecting plate 150 may be fixed to the second distributing surface 114 of the distributing plate 110 using the bolt 190. The bolt 190 may be threaded from the lower surface of the distributing plate 110 to the second protecting plate 150. Thus, the bolt 190 may have the head exposed through the receiving groove 119. In contrast, the bolt 190 may have an end exposed through the upper surface of the second protecting plate 150. In order to prevent the end of the bolt 190 from being crushed and worn with the natural aggregates, a protecting tip 192 may be attached to the end of the bolt 190. The protecting tip 192 may be attached to the end of the bolt 190 by a brazing process.

The third protecting plate 160 may protect the outer surface 118 of the distributing plate 110. The third protecting plate 160 may be configured to make contact with the outer surface 118 of the distributing plate 110. In example embodiments, the third protecting plate 160 may have an annular shape. Thus, the third protecting plate 160 may have an upper surface, a lower surface, an inner surface 162 and an outer surface 164. The upper surface of the third protecting plate 160 may make contact with the outer surface 134 of the outer protecting plate 130. The lower surface of the third protecting plate 160 may be positioned coplanar with the lower surface of the distributing plate 110. The inner surface 162 of the third protecting plate 160 may make contact with the outer surface 118 of the distributing plate 110.

As mentioned above, because the outer surface 118 of the distributing plate 118 may have the gradually increased width from the upper surface to the lower surface of the distributing plate 110, the inner surface 162 of the third protecting plate 160 may have a gradually decreased width from the upper surface to the lower surface of the distributing plate 110. The third protecting plate 160 may include a hard metal such as tungsten carbide. The third protecting plate 160 may function as to protect the outer surface 118 of the distributing plate 110 from the crushing of the natural aggregates.

The fourth protecting plate 170 may protect the inner surface 116 of the distributing plate 110. The fourth protecting plate 170 may be configured to make contact with the inner surface 116 of the distributing plate 110. In example embodiments, the fourth protecting plate 170 may have an annular shape. Thus, the fourth protecting plate 170 may have an upper surface, a lower surface, an inner surface and an outer surface. The inner surface of the fourth protecting plate 170 may be exposed through the axial hole 113. The outer surface of the fourth protecting plate 170 may make contact with the inner surface 116 of the distributing plate 110. The upper surface of the fourth protecting plate 170 may be protruded from the second distributing surface 114. A protruded portion of the fourth protecting plate 170 from the second distributing surface 114 may be received in the receiving groove 156 of the second protecting plate 150. Thus, the fourth protecting plate 170 may be firmly combined with the distributing plate 110 and the second protecting plate 150 by receiving the protruded portion of the fourth protecting plate 170 in the receiving groove 156 of the second protecting plate 150. The fourth protecting plate 170 may include a hard metal such as tungsten carbide. The fourth protecting plate 170 may function as to protect the inner surface 116 of the distributing plate 110 from the crushing of the natural aggregates.

The distributing plate 110 may be fixed to the vertical shaft using a bolt 180. The bolt 180 may be inserted into the axial hole 113 to fix the distributing plate 110 to the vertical shaft. Thus, the bolt 180 may have a head oriented upwardly in the axial hole 113. The natural aggregates may be crushed against the head of the bolt 180 to reduce a connection force between the bolt 180 and the vertical shaft. Thus, a protecting cover 182 may be attached to the head of the bolt 180. The protecting cover 182 may include a hard metal such as tungsten carbide. The protecting cover 182 may be attached to the head of the bolt 180 by a brazing process.

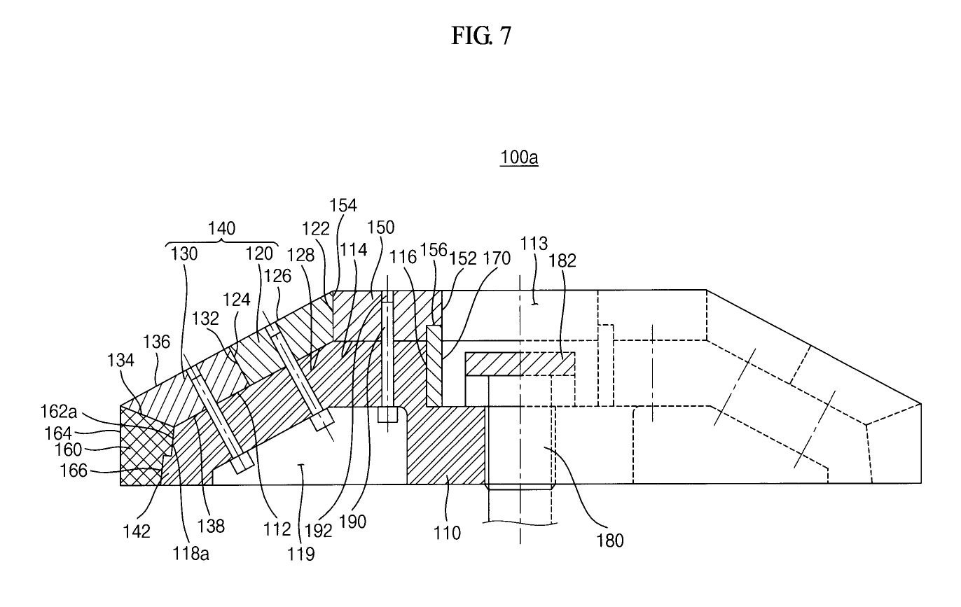

FIG. 7 is a cross-sectional view illustrating a distribution member of a vertical shaft impact crusher in accordance with example embodiments.

A distribution member 100a of this example embodiment may include elements substantially the same as those of the distribution member 100 in FIG. 1 except for a connection structure between the distributing plate 110 and the third protecting plate 160. Thus, the same reference numerals may refer to the same elements and any further illustrations with respect to the same elements may be omitted herein for brevity.

Referring to FIG. 7, an outer surface 118a of the distributing plate 110 may not have a tapered shape. The outer surface 118a of the distributing plate 110 may be substantially parallel to the axial direction of the axial hole 113. A locking portion 142 may be formed at the outer surface 118a of the distributing plate 110. Particularly, the locking portion 142 may be formed at a low portion of the outer surface 118a. That is, the locking portion 142 may be extended upwardly from a lower end of the outer surface 118a of the distributing plate 110.

An inner surface 162a of the third protecting plate 160 may be configured to make contact with the outer surface 118a of the distributing plate 110. Thus, the inner surface 162a of the third protecting plate 160 may be substantially parallel to the outer surface 118a of the distributing plate 110. A locking groove 166 may be formed at the inner surface 162a of the third protecting plate 160. The locking portion 142 may be supported by the locking groove 166. The locking groove 166 may be formed upwardly from a lower end of the inner surface 162a of the third protecting plate 160.

Alternatively, the third protecting plate 160 and the distributing plate 110 may be connected with each other using other connection structures obvious skilled in the art.

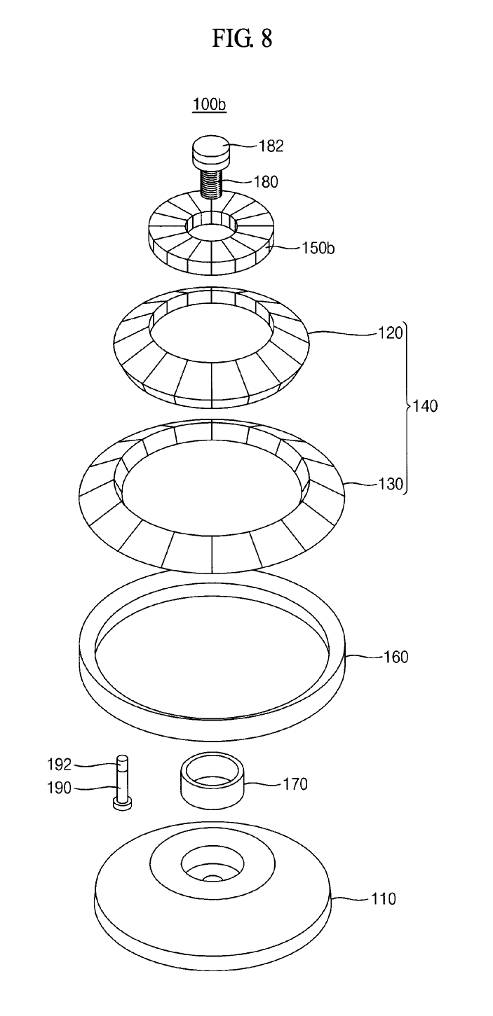

FIG. 8 is a cross-sectional view illustrating a distribution member of a vertical shaft impact crusher in accordance with example embodiments.

A distribution member 100b of this example embodiment may include elements substantially the same as those of the distribution member 100 in FIG. 1 except for a second protecting plate. Thus, the same reference numerals may refer to the same elements and any further illustrations with respect to the same elements may be omitted herein for brevity.

Referring to FIG. 8, a second protecting plate 150b may include a plurality of plates. The second protecting plates 150b may be configured to make contact with the second distributing surface 114 of the distributing plate 110. The second protecting plates 150b may be arranged in the circumferential line of the second distributing surface 114 of the distributing plate 110. The circumferential line may correspond to a line connecting the second distributing surface 114 of the distributing plate 110 with each other. The second protecting plates 150b may have substantially the same size and shape. Each of the second protecting plates 150b may have an isosceles trapezoidal shape.

The second protecting plates 150b may be fixed to the distributing plate 110 using the bolt 190. A relatively more worn plate among the second protecting plates 150b may be exchanged with a new plate. The second protecting plate 150b may be easily exchanged using the bolt 190.

Vertical Shaft Impact Crusher

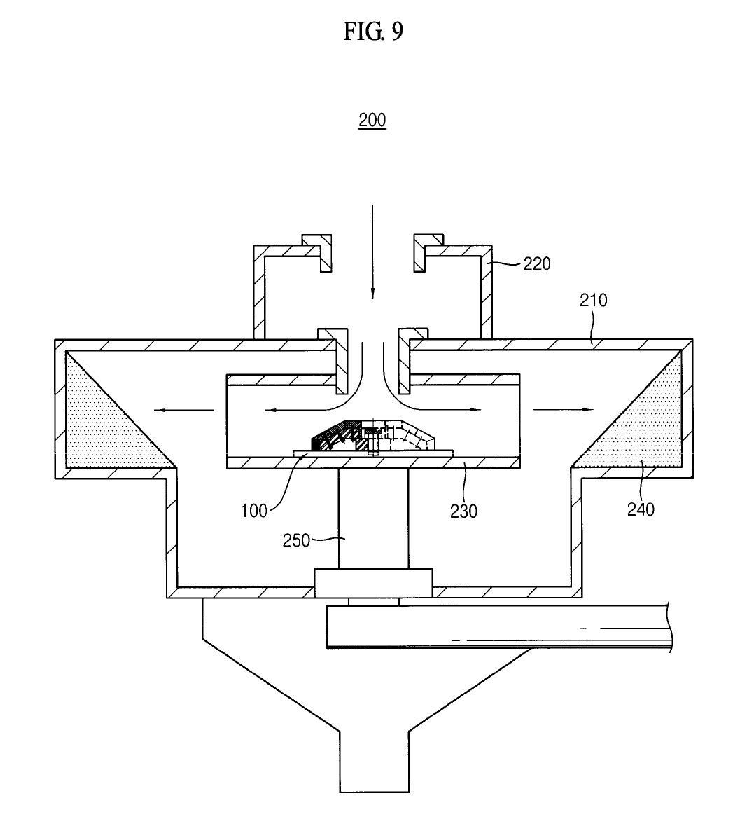

FIG. 9 is a cross-sectional view illustrating a vertical shaft impact crusher including the distribution member in FIG. 1.

Referring to FIG. 9, a vertical shaft impact crusher 200 of this example embodiment may include a crushing chamber 210, a feeding hopper 220 and a rotor 230. The feeding hopper 220 may be arranged over the crushing chamber 210. The rotor 230 may be arranged at an upper portion in the crushing chamber 210. The rotor 230 may be in fluidic communicated with the feeding hopper 220. The natural aggregates may be loaded into the rotor 230 in the vertical direction through the feeding hopper 220. The rotor 230 may be connected to the vertical shaft 250. Thus, the rotor 230 may be rotated by the vertical shaft 250.

The distribution member 100 may be arranged at a central portion of a bottom surface of the rotor 230. The distribution member 100 may horizontally distribute the natural aggregates vertically loaded into the rotor 230. The distribution member 100 may be connected with the vertical shaft 250 through the bolt 180 for rotating the rotor 230. Thus, the distribution member 100 may be rotated together with the rotor 230.

The distribution member 100 of this example embodiment may include elements substantially the same as those of the distribution member 100 in FIG. 1. Thus, the same reference numerals may refer to the same elements and any further illustrations with respect to the same elements may be omitted herein for brevity. Alternatively, the vertical shaft impact crusher 200 may include the distribution member 100a in FIG. 7 or the distribution member 100b in FIG. 8.

An anvil 240 may be installed at an inner surface of the crushing chamber 210. The natural aggregates horizontally distributed by the distribution member 100 may be crushed against the anvil 240.

The natural aggregates may be vertically loaded into the rotor 230 through the feeding hopper 220. The natural aggregates may be crushed against the first protecting plates 140 and the second protecting plate 150 of the distribution member 100. The crushed natural aggregates may then be horizontally distributed. Here, because the first protecting plates 140 and the second protecting plate 150 may include the hard metal, the first protecting plates 140 and the second protecting plate 150 may have good wear resistance with respect to the natural aggregates. Therefore, the distributing plate 110 may be semi-permanently used by properly exchanging the first protecting plates 140 and/or the second protecting plate 150. Particularly, because the first protecting plate 140 including the hard metal may include the inner protecting plates 120 and the outer protecting plates 130, relatively more worn one among the inner and outer protecting plates 120 and 130 may be selectively exchanged with a new protecting plate.

The horizontally distributed natural aggregates may be crushed against the anvil 240 to be pulverized into gravels and sands. The gravels and the sands may be unloaded from the crushing chamber 210 through an exit.

According to example embodiments, the first protecting plates and the second protecting plate including the hard metal may prevent the first protecting surface and the second protecting surface of the distributing plate from being worn. Particularly, any one among the first protecting plates, which may be relatively more worn, may be exchanged with a new one. Thus, the distribution member may be semi-permanently used by properly exchanging any one of the first protecting plates and/or the second protecting plate.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A distribution member of a vertical shaft impact crusher comprising:
a distributing plate connected with a vertical shaft of the vertical shaft impact crusher, the distributing plate having a conical first distributing surface and a second distributing surface;
a plurality of first protecting plates attached to the first distributing surface of the distributing plate; and
a second protecting plate attached to the second distributing surface of the distributing plate.

2. The distribution member of the vertical shaft impact crusher of claim 1, wherein the second distributing surface is substantially perpendicular to an axial direction of the vertical shaft, and the first distributing surface is slantly extended from an outer end of the second distributing surface in a radius direction of the distributing plate.

3. The distribution member of the vertical shaft impact crusher of claim 1, wherein the distributing plate has a receiving groove configured to receive bolts for fixing the first and second protecting plates to the first and second distributing surfaces, respectively.

4. The distribution member of the vertical shaft impact crusher of claim 3, wherein a protecting tip is attached to an end of the bolt oriented toward the first and second protecting plates.

5. The distribution member of the vertical shaft impact crusher of claim 4, wherein the protecting tip comprises a hard metal.

6. The distribution member of the vertical shaft impact crusher of claim 1, wherein the first protecting plates comprise:
a plurality of inner protecting plates arranged in a circumferential direction of the distributing plate, each of the protecting plates having an inner surface configured to make contact with an outer surface of the second protecting plate; and
a plurality of outer protecting plates arranged in the circumferential direction of the distributing plate, the outer protecting plate configured to make contact with outer surface of the inner protecting plates.

7. The distribution member of the vertical shaft impact crusher of claim 6, wherein each of the inner and outer protecting plates has rounded upper and lower surfaces.

8. The distribution member of the vertical shaft impact crusher of claim 1, wherein the second protecting plate comprises a plurality of plates arranged in a circumferential direction of the second distributing surface of the distributing plate.

9. The distribution member of the vertical shaft impact crusher of claim 1, further comprising a third protecting plate attached to an outer surface of the distributing plate.

10. The distribution member of the vertical shaft impact crusher of claim 9, wherein the outer surface of the distributing plate has a tapered shape, and an inner surface of the third protecting plate makes contact with the tapered outer surface of the distributing plate.

11. The distribution member of the vertical shaft impact crusher of claim 9, wherein a locking portion is formed at the outer surface of the distribution plate, and a locking groove configured to receive the locking portion is formed at the inner surface of the third protecting plate.

12. The distribution member of the vertical shaft impact crusher of claim 9, wherein the third protecting plate comprises a hard metal.

13. The distribution member of the vertical shaft impact crusher of claim 1, further comprising a fourth protecting plate attached to an inner surface of the distributing plate.

14. The distribution member of the vertical shaft impact crusher of claim 13, wherein the fourth protecting plate comprises an upper end protruded from the second distributing surface, and the second protecting plate has a receiving groove configured to receive the upper end of the fourth protecting plate.

15. The distribution member of the vertical shaft impact crusher of claim 13, wherein the fourth protecting plate comprises a hard metal.

16. The distribution member of the vertical shaft impact crusher of claim 1, wherein the first protecting plates and the second protecting plate comprise a hard metal.

17. The distribution member of the vertical shaft impact crusher of claim 1, further comprising a bolt configured to connect the distributing plate with the vertical shaft.

18. The distribution member of the vertical shaft impact crusher of claim 17, wherein a protecting cover is attached to a head of the bold.

19. The distribution member of the vertical shaft impact crusher of claim 18, wherein the protecting cover comprises a hard metal.

20. A vertical shaft impact crusher comprising:
a crushing housing;
a feeding hopper arranged over the crushing housing to provide the crushing housing with natural aggregates;
a rotor arranged in the crushing housing to provide the aggregates with a centrifugal force;
a vertical shaft configured to provide the rotor with the centrifugal force;
a distribution member arranged on a bottom surface of the rotor, the distribution member including a distributing plate connected with a vertical shaft of the vertical shaft impact crusher, the distributing plate having a conical first distributing surface and a second distributing surface, a plurality of first protecting plates attached to the first distributing surface of the distributing plate, and a second protecting plate attached to the second distributing surface of the distributing plate; and
an anvil configured to be crushed against the natural aggregates horizontally distributed by the distribution member.
